(19) United States
(12) Patent Application Publication
(10) Pub. No.: US 2014/0091653 A1
(43) Pub. Date: Apr. 3, 2014

(54) MOTOR HAVING HIGHLY-EFFICIENT AIR-COOLING STRUCTURE

(71) Applicant: FANUC CORPORATION, Yamanashi (JP)

(72) Inventor: Takeshi Saitou, Yamanashi (JP)

(73) Assignee: FANUC CORPORATION, Yamanashi (JP)

(21) Appl. No.: 14/031,229

(22) Filed: Sep. 19, 2013

(30) Foreign Application Priority Data
Sep. 28, 2012 (JP) 2012-216191

(51) Int. Cl. H02K 9/04

(52) U.S. Cl. CPC H02K 9/04
USPC 310/59; 310/63

(57) ABSTRACT

A motor with an air-cooling structure having high cooling efficiency and capable of avoiding an increase in the size of the motor. A stator of the motor has an air flow channel being formed in the stator near outer circumferences of the slots. Air conveyed from a fan motor collides with an inner surface of an end at a spindle side of the stator, while cooling the slots through the air flow channel. The flowing direction of air which collides with the housing is inverted by a redirecting part, and the air is returned to the fan motor side while cooling the outside of the stator.

### BACKGROUND OF THE INVENTION

1. Field of the Invention

The present invention relates to a motor having an air-cooling structure, in particular, a motor having an air-cooling structure used to drive a spindle of a machine tool

2. Description of the Related Art

Generally, when a motor used to a spindle of a machine tool is cooled by air by means of a fan motor, in order to avoid deterioration of processing accuracy due to a thermal displacement of the spindle generated by exhaust air toward a column of the machine tool, a structure for directing the air away from the spindle (in the direction opposite to an output shaft) is used. For example, Japanese Unexamined Patent Publication (Kokai) No. H10-235536 discloses a spindle cooling device having a spindle 11 and cooling jackets 19a to 19c for covering at least left, right and front parts of the spindle, wherein the device has a structure for supplying cooling air from a tool attachment side into the cooling jackets and for exhausting the cooling air from the side of a spindle motor 15.

Japanese Unexamined Patent Publication (Kokai) No. 2007-336721 discloses an air-cooling motor, wherein a spacer 18 having a closed hollow space, which covers a connecting part between a through hole 11 of a motor shaft 1 and a coolant supply 12, is arranged at an end of a bracket 6 fixed on a counter-load side of an outer cylinder 4 of a motor. In relation to the direction of cooling air parallel to motor shaft 1, a cooling fan 16 is arranged at a rear side of spacer 18, and an air hole 17 is formed on bracket 6 at the counter-load side for communicating spacer 18 and a space between outer cylinder 4 and a covered plate 14.

Further, Japanese Unexamined Patent Publication (Kokai) No. 2005-124266 discloses a cooling structure of an electric motor, which is configured to cover an outer circumference of a stator 6 and has a vent hole 8 communicated with a load-side of a vent hole 9. The cooling structure has a guide 4 having one end attached to a load-side bracket 3 and another end having an opening 4B for sucking cooling air from a counter-load side.

In the motor wherein the fan motor is attached to the side opposite to the output shaft side for air-cooling, it is known based on experiments, when the exhaust direction corresponds to the direction away from the output shaft, cooling efficiency is inferior as compared with when the exhaust direction corresponds to terms of cooling, it is disadvantageous that exhaust air is discharged in the direction opposite to the output shaft so that the exhaust air does not collide with the column of the machine tool.

The structure for introducing cooling air in the direction opposite to the output shaft by means of the attached the cooling jacket, as described in Japanese Unexamined Patent Publication (Kokai) No. H10-235536 and Japanese Unexamined Patent Publication (Kokai) No. 2007-336721, is inefficient in cooling as described above, and has a problem of the motor being large due to the attached cooling jacket.

On the other hand, Japanese Unexamined Patent Publication (Kokai) No. 2005-124266 discloses a structure for inverting the flow direction of the cooling air by means of guide 4 near load-side bracket 3. However, also in this structure, the flow direction of the cooling air when cooling the motor corresponds to the direction opposite to the output shaft (or the counter-load side direction), and there is also a problem of the entire structure being large due to guide 4.

### SUMMARY OF THE INVENTION

The object of the present invention is to provide a motor with an air-cooling structure having high cooling efficiency and capable of avoiding an increase in size of the motor.

The present invention provides a factor comprising a stator, a plurality of slots circularly arranged about a center of the stator, and a fan motor positioned at a side opposite to an output shaft of the stator, wherein the stator has an air flow channel extending in an axial direction, the air flow channel being formed in the stator near outer circumferences of the slots, and wherein air from the fan motor is directed toward an end at an output shaft side through the air flow channel, and a flow direction of the air is inverted at the end at the output shaft side so that the air is directed toward the side opposite to the output shaft.

In a preferred embodiment, the stator comprises an exhaust port formed near the end at the output shaft side of the stator, and a guide member for guiding air so that the air discharged from the exhaust port flows toward the side opposite to the output shaft.

In this case, the plurality of slots cooperatively may constitute a circular cross section, the stator may have a non-circular cross-section surrounding the circular cross-section, and the air flow channel may be partially formed on the entirety of an outer circumferential circle defined by the plurality slots, wherein the exhaust port may be arranged so that the air discharged from the exhaust port contacts a surface of a portion where the air flow channel is not formed with respect to a circumferential direction.

In a preferred embodiment, the stator has inside and outside air flow channels extending in the axial direction, the inside air flow channel being formed in the stator near outer circumferences of the slots, and the outside air flow channel being formed in the stator near a radially outside portion the inside air flow channel and fluidly communicated with the inside air flow channel at the end at the output shaft side.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 is a perspective view showing a schematic configuration of a motor according to a first embodiment of the invention;

FIG. 2 shows a radial cross-section of the motor of FIG. 1;

FIG. 3 is a view schematically explaining a structure around a housing of a stator in the motor of FIG. 1;

FIG. 4 shows a radial cross-section of a motor according to a second embodiment of the invention; and

FIG. 5 is a view schematically explaining a structure around a housing of a stator in the motor of FIG. 4.

### DETAILED DESCRIPTION

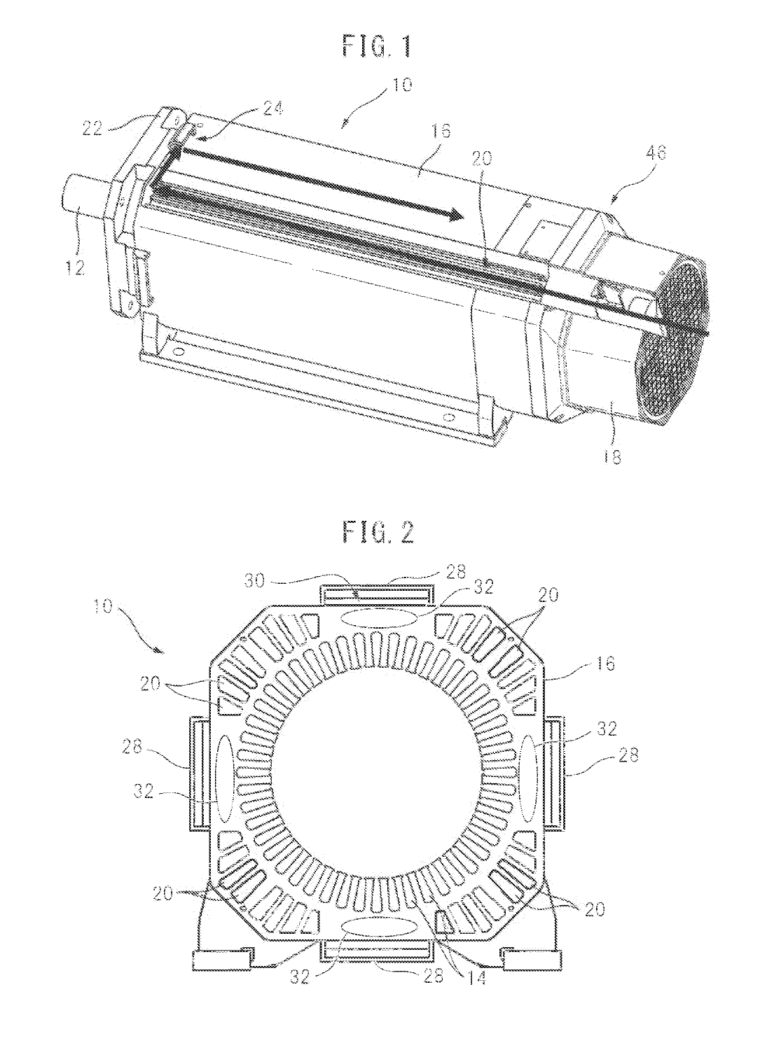

FIG. 1 is a perspective view showing a schematic configuration of a motor 10 according to a first embodiment of the invention, and a part of which is removed for clarity. For example, motor 10 is a motor for rotatably driving a spindle of a schematically shown machine tool. Motor 10 has an output shaft 12 connected to the spindle, a stator 16 having a plurality of slots 14 therein (see FIG. 2), a rotor (not shown) arranged coaxially with stator 16 and connected to output shaft 12, and a fan motor 18. Fan motor 18 is attached to an end surface of stator 16 opposite to output shaft 12 (or the counter-spindle side), and is configured to blow air toward output shaft 12 through stator 16 in an axial direction thereof.

FIG. 2 shows a radial cross-section (or a cross-section perpendicular to the axial direction of output shaft 12) of motor 10 of FIG. 1. Within stator 16, slots 14 are circularly arranged about a center of stator 16 (in the circumferential direction). Each slot 14 has an elongated shape extending in a generally radial direction in FIG. 2 (or in the radial cross-section), and a winding wire (not shown) is wound around in each slot. Stator 16 has an air flow channel 20 extending in the axial direction, the air flow channel being formed in the stator near or adjacent outer circumferences of slots 14. Air conveyed from fan motor 18 collides with an inner wall of an end at an output shaft side (a housing 22 in the drawing) of stator 16, while cooling slots 14 through air flow channel 20.

As shown in FIG. 3, the flowing direction of the air which collides with housing 22 is changed by a redirecting part 24 arranged at or near housing 22. Concretely, redirecting part 24 is constituted by housing 22, an exhaust port 26 formed near the housing of stator 16, and a guide member 28 for guiding the air discharge from the exhaust port so as to flow toward the counter-spindle side. Guide member 28 has an opening 30 which is opened toward the counter-spindle side. Due to such a constitution, the flowing direction of the air conveyed from fan motor 18 through air flow channel 20 is inverted by redirecting part 24, as indicated by an arrow in FIG. 3, and the air is returned to the side of fan motor 18 while cooling the outside of stator 16.

As shown, the first embodiment is particularly advantageous when slots 14, which cooperatively constitute the generally circular cross-section, are formed in stator 16 with a non-circular cross-section (for example, the stator having a generally cuboid shape with the non-circular cross-section). In such a constitution, the size of stator 16 may be minimized as much as possible for downsizing and weight-saving of the entire motor, and thus air flow channel 20 may not have to be arranged around the entire circumference of slots 14. As such, when an flow channel 20 is partially formed around the entire circumference of slots 14, a portion (indicated by reference numeral 32 in FIG. 2) where air flow channel 20 is not formed in the circumferential direction may not be sufficiently cooled. However, by constituting the exhaust port and the guide member so that the air discharged from opening 30 contacts a surface of portion 32 (i.e., the portion is cooled by heat exchange with the air), portion 32 can be properly cooled. In addition, stator 16 may be manufactured by stacking a plurality of thin magnetic steel plates in the axial direction, wherein slots 14 and air flow channel 20 are formed in each plate, as shown in FIG. 2.

FIG. 4 shows a radial cross-section (or a cross-section perpendicular to the axial direction of output shaft 12) of a motor 40 according to a second embodiment of the invention. The second embodiment is different from the first embodiment in that the exhaust port and the guide member are not arranged and the air flow channel is separated into inside and outside areas with respect to the radial direction. Since the other components of the second embodiment may be the same as the first embodiment, the same reference numerals are added to the corresponding components and a detailed explanation thereof will be omitted.

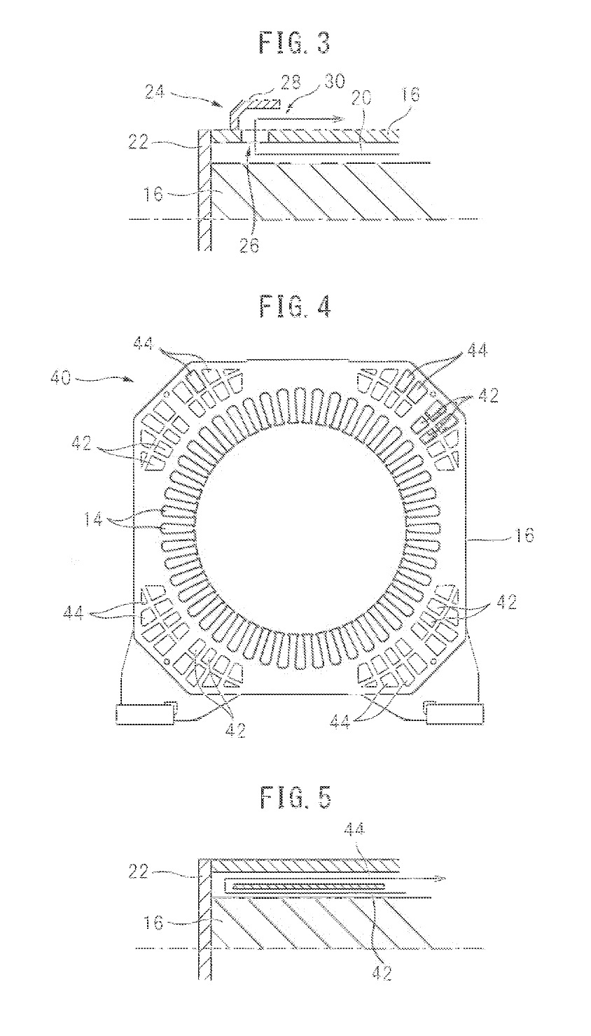

In the second embodiment, stator 16 has an inside air flow channel 42 arranged near or adjacent the outer circumference of slots 14 while extending in the axial direction, and an outside air flow channel 44 arranged near or adjacent the outer radial circumference of inside air flow channel 42 while extending in the axial direction. Air from fan motor 18 collides with an end at the spindle side (housing 22 in the drawing) of stator 16, while cooling slots 14 through inside air flow channel 42. As shown in FIG. 5, the flowing direction of the air which collides with housing 22 is changed at housing 22, and the air flows into outside air flow channel 44 and progresses in the counter-spindle direction within outside air flow channel 44. In other words, in the second embodiment, inside and outside air flow channels 42 and 44 extend parallel to each other, and are fluidly communicated with each other only near housing 22 so that the portion of housing 22, with which the air passing through inside air flow channel 42 collides, functions as a redirecting part.

The air passing through outside air flow channel 44 may be discharged from an opening formed on an appropriate position of stator 16. In this regard, in order to obtain higher cooling effect, it is preferable that an opening (not shown) communicated with outside air flow channel 44 be formed in the vicinity of the fan motor (for example, the opening may be formed at a connection part or a stepped part 46 between stator 16 and fan motor 18 in FIG. 1) so that the air is discharged from the opening. Further, stator 16 may be manufactured by stacking a plurality of thin magnetic steel plates in the axial direction, wherein inside and outside air flow channels 42 and 44 are formed in each plate, as shown in FIG. 4.

In any of the above embodiments, the cooling air from fan motor 18 flows toward output shaft 12, whereby higher cooling effect than the prior art can be obtained. Since the flowing direction of the cooling air is inverted at the end at the output shaft side (or housing 22), the air does not reach the structure such as a column of the machine tool positioned at the output shaft side, whereby the structure is not adversely affected by the air.

In addition, the above first and second embodiments may be combined. In other words, an exhaust port equivalent to exhaust port 26 of FIG. 1 may be arranged in the constitution of FIG. 4 so that the air inverted at the housing flows into both outside air flow channel 44 and the exhaust port.

According to the present invention, since the cooling air from the fan motor flows toward the output shaft of the motor, more effective cooling than the prior art can be carried out. Further, since the flowing direction of the cooling air is inverted at the end at the output shaft side of the housing, the structure positioned at the output shaft side is not adversely affected by the cooling air.

By using the exhaust port and the guide member positioned near the end of the output shaft side, as a means for inverting the flowing direction of the cooling air, an increase in size of the entire motor can be avoided. Further, even when the air flow channel within the stator is not formed along the whole outer circumference of the slots, the portion where the air flow channel does not exist (i.e., the position which is difficult to cool) can be properly cooled due to the constitution including the exhaust port and the guide member.

An increase in size of the entire motor may also be avoided, by forming the inside and outside air flow channels extending in the axial direction, the inside air flow channel being formed in the stator near outer circumferences of the slots, and the outside air flow channel being formed in the stator near the radially outside portion the inside air flow channel and fluidly communicated with the inside air flow channel at one end at the output shaft side.

While the invention has been described with reference to specific embodiments chosen for the purpose of illustration, it should be apparent that numerous modifications could be made thereto, by a person skilled in the art, without departing from the basic concept and scope of the invention.

1. A motor comprising a stator, a plurality of slots circularly arranged about a center of the stator, and a fan motor positioned at a side opposite to an output shaft of the stator,
wherein the stator has an air flow channel extending in an axial direction, the air flow channel being formed in the stator near outer circumferences of the slots,
and wherein air from the fan motor is directed toward an end at an output shaft side through the air flow channel, and a flow direction of the air is inverted at the end at the output shaft side so that the air is directed toward the side opposite to the output shaft.

2. The motor as set forth in claim 1, wherein the stator comprises an exhaust port formed near the end at the output shaft side of the stator, and a guide member for guiding air so that the air discharged from the exhaust port flows toward the side opposite to the output shaft.

3. The motor as set forth in claim 2, wherein the plurality of slots cooperatively constitute a circular cross-section, the stator has a non-circular cross-section surrounding the circular cross-section, and the air flow channel is partially formed on the entirety of an outer circumferential circle defined by the plurality slots,
and wherein the exhaust port is arranged so that the air discharged from the exhaust port contacts a surface of a portion where the air flow channel is not formed with respect to a circumferential direction.

4. The motor as set forth in claim 1, wherein the stator has inside and outside air flow channels extending in the axial direction, the inside air flow channel being formed in the stator near outer circumferences of the slots, and the outside air flow channel being formed in the stator near a radially outside portion the inside air flow channel and fluidly communicated with the inside air flow channel at the end at the output shaft side.
